(19) United States
(12) Patent Application Publication
(10) Pub. No.: US 2009/0142596 A1
(43) Pub. Date: Jun. 4, 2009

(54) METHOD FOR PRODUCING MULTI-LAYERED SURFACE STRUCTURES, PARTICLES OR FIBRES

(75) Inventors: Uwe Freudenberg, Dresden (DE); Stefan Zschoche, Fujeira (DE); Carsten Werner, Dresden (DE); Kati Schmidt, Ludwigshafen (DE); Sven Holger Behrens, Mannheim (DE); Helmut Auweter, Limburgerhof (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/718,048

(22) PCT Filed: Oct. 20, 2005
(86) PCT No.: PCT/EP05/11302

§ 371 Date: Apr. 26, 2007

(30) Foreign Application Priority Data
Oct. 26, 2004 (DE) 10 2004 052 120.4

(51) Int. Cl. B05D 3/10; B05D 7/00; B32B 27/06; B32B 15/02; D02G 3/00

(52) U.S. Cl. 428/378; 427/333; 427/214; 428/481; 428/407

(57) ABSTRACT

The process for producing multilayered sheetlike structures, particles or fibers comprises the steps of
(a) applying a reactive polycarboxylic acid or one of its derivatives atop a sheetlike, particulate or fibrous carrier material already comprising, or previously provided with, groups reactive toward, capable of covalent bonding with, the polycarboxylic acid or one of its derivatives,
(b) if appropriate heating the carrier material treated in step (a) to a temperature in the range from 60° C. to 130° C. and preferably to a temperature in the range from 80° C. to 120° C. to hasten, complete or further optimize the covalent bonds,
(c) applying atop the carrier material a cellulose capable of covalent bonding with the polycarboxylic acid or its derivatives.

The present invention further relates to the use of the present invention's process for production of multilayered sheetlike structures, particles or fibers for hydrophilicizing surfaces, in particular for adhesion promotion between hydrophobic and hydrophilic materials and for improving the washability of synthetic fibers, the surfaces which are hydrophilicized by the process forming the sheetlike, particulate or fibrous carrier material.

The present invention relates to a process for production of multilayered sheetlike structures, particles or fibers and also to multilayered sheetlike structures, particles or fibers producible i.e., obtainable by this process. The present invention further relates to multilayered sheetlike structures, particles or fibers comprising a reactive polycarboxylic acid derivative bound to a sheetlike, particulate or fibrous carrier material by a covalent bond and a cellulose layer. The present invention also relates to the use of the identified multilayered sheetlike structures, particles or fibers for hydrophilicizing surfaces.

Processes for production of multilayered sheetlike structures, particles or fibers by application of cellulose atop a sheetlike, particulate or fibrous carrier material are described several times in the prior art.

Gunnars et al. (Cellulose (2002) 9:239-249: “Model films of cellulose: I. Method development and initial results”) describe the production of thin cellulose films, from 20 nm to 270 nm thick, which are noncovalently attached via a saturated polymeric layer. The disadvantage with this way of binding cellulose layer, solely through physical adsorption, is the lack of stability, especially to the action of shearing forces.

The application of a reactive polycarboxylic acid derivative atop a sheetlike, particulate or fibrous carrier material comprising groups capable of covalent bonding is likewise described in the prior art.

Pompe et.al. (Biomacromolecules (2003) 4:1072-1079: “Maleic anhydride Copolymers—a versatile platform for molecular biosurface engineering”) disclose applying an alternating maleic anhydride copolymer atop a sheetlike carrier material previously provided with groups capable of covalent bonding. The surface thus obtained is used to attach molecules having different functional groups, for example 1,4-butanediamine, which are to provide sites where bioactive molecules, for example proteins, are to be immobilized. Attachment of cellulose to the surfaces thus obtained is not described.

U.S. Pat. No. 6,379,753 B1 describes a process for producing multilayered fibers, the process comprising attaching a maleic anhydride polymer to existing hydroxyl, amino, sulfhydryl or carboxyl groups of wool, cotton or manufactured fibers. The maleic anhydride polymer is applied from an aqueous solution, and the reaction proceeds under NaH₂PO₂ catalysis and also under application of heat, although the temperature range is not defined. Similarly, covalent bonding of cellulose to the dissolved maleic anhydride polymer is described, followed by the covalent attachment of the cellulose-attached maleic anhydride polymer to the carrier material. The disadvantages of such a sequence of reactions include, for example, the construction of the cellulose layer being possibly affected by the subsequent coupling reaction to the carrier material and the difficulty of influencing the thickness of the cellulose layer which is formed, given that the reaction takes place in solution.

A further example of covalent bonding of biological molecules to dissolved maleic anhydride polymers is described in EP-A 0 561 722. In the initial step of the process disclosed therein a maleic anhydride polymer is dissolved in an organic solvent and subsequently rendered water soluble by derivatization. These derivatized maleic anhydride polymers may be additionally modified such that they can be directly or indirectly immobilized on a solid carrier material. The molecule thus obtained is finally coupled to a biological molecule, for example to a protein. The attachment of polysaccharides to the hydrophilicized maleic anhydride polymers is only described for the purpose of immobilization to solid carrier materials, i.e., the polysaccharide is in this case between the maleic anhydride polymer and the carrier material and does not form the uppermost layer of a multilayered sheetlike structure. Similarly to U.S. Pat. No. 6,379,753 cited above, coupling of the functionalizing polysaccharide to the maleic anhydride polymer takes place in this process prior to attachment to a solid carrier material. Hence the disadvantages mentioned above apply here as well.

The present invention has for its object to develop a process for stable attachment of cellulose layers to different carrier materials wherein the construction of the cellulose layers is not impaired and the carrier materials can be present in any desired form.

We have found that this object is achieved by a process for producing multilayered sheetlike structures, particles or fibers, the process comprising the steps of
(a) applying a reactive polycarboxylic acid derivative atop a sheetlike, particulate or fibrous carrier material already comprising, or previously provided with, groups reactive toward, capable of covalent bonding with, the polycarboxylic acid derivative,
(b) if appropriate heating the carrier material treated in step (a) to a temperature in the range from 60° C. to 130° C. and preferably to a temperature in the range from 80° C. to 120° C. to hasten, complete or further optimize the covalent bonds,
(c) applying atop the carrier material a cellulose capable of covalent bonding with the polycarboxylic acid derivative.

The present invention further provides multilayered sheetlike structures, particles or fibers that are obtainable by the process mentioned.

The present invention further provides multilayered sheetlike structures, particles or fibers, in particular multilayered sheetlike structures or particles, comprising polycarboxylic acid derivatives bound to a sheetlike, particulate or fibrous carrier material and a cellulose layer, wherein the cellulose layer consists of a first cellulose layer, bound covalently to the polycarboxylic acid derivatives, and a second cellulose layer, bound noncovalently to the first cellulose layer.

The present invention further provides for the use of the present invention's multilayered sheetlike structures, particles or fibers and process for production of multilayered sheetlike structures, particles or fibers for hydrophilicizing surfaces, in particular for adhesion promotion between hydrophobic and hydrophilic materials and for improving the washability of synthetic fibers, the surfaces which are hydrophilicized by the process forming the sheetlike, particulate or fibrous carrier material.

As used herein, “reactive polycarboxylic acid derivative” refers to a molecule which comprises more than one reactive derivative of a carboxyl group, for example a carboxylic anhydride, a carbonyl chloride or an activated carboxylic ester, in particular a carboxylic anhydride, and is capable of forming a covalent bond with functional groups of another molecule through at least one of the reactive carboxyl group derivatives, in particular to form amide or ester bonds.

“To further optimize the covalent bonds” is herein to be understood as meaning in particular the heat-catalyzed conversion into cyclic, stable-to-hydrolysis imide bonds of amide bonds initially formed when a reactive polycarboxylic acid derivative is applied atop a sheetlike, particulate or fibrous carrier material already comprising, or previously provided with, groups reactive toward, capable of covalent bonding with, the polycarboxylic acid derivative.

“Groups capable of covalent bonding” is herein to be understood as meaning reactive, functional groups such as amino, hydroxyl, sulfhydryl and carboxyl groups that are capable of reacting with the reactive polycarboxylic acid derivative substantially spontaneously and without addition of a catalyst by forming a covalent bond.

“Cellulose capable of covalent bonding” is similarly to be understood as meaning cellulose molecules comprising reactive hydroxyl groups capable of reacting with the reactive polycarboxylic acid derivative substantially spontaneously and without addition of a catalyst by forming a covalent bond.

As used herein, “carrier material” refers to a sheetlike, particulate or fibrous solid in any desired form which already comprises, or can be provided with, groups which are reactive toward, capable of covalent bonding with, the polycarboxylic acid derivative.

As used herein, “plastics” is to be understood as referring to materials whose basic constituent is manufactured from synthetic or natural polymers and which are in the form of chips, fibers or self-supporting films for example.

As used herein, “sheetlike carrier material” is to be understood as meaning for example a carrier material in the form of plates, disks, grids, membranes or self-supporting films. As used herein, “particulate carrier material” refers to particles from 10 nm to 100 μm and preferably from 20 nm to 5 μm in size, preferably consisting of silicates, silica gel particles, talcum, clay minerals, metal oxides, especially zinc oxide and titanium oxide, calcium carbonate, calcium sulfate or barium sulfate. As used herein, “fibrous carrier material” refers to fibers from 5 to 500 μm thick preferably consisting of cellulose or cellulose derivatives, polyamides, polyesters, polyurethanes or polypropylene

As used herein, “amine-terminated alkylsilanes” refers to alkylsilanes having a primary amino group attached to a terminal carbon atom. 3-Aminopropyldimethyl-ethoxysilane is an example.

As used herein, “pretempered carrier material” refers to a carrier material which is preferably preheated to a temperature in the range from 40° C. to 120° C., more preferred 40° C. to 80° C., before a solution, for example a cellulose solution, is applied.

As used herein, “improved washability” of fibers is to be understood as meaning in particular an improved spreadability, i.e., an enhanced wettability of the fiber with water.

The process of the present invention has the following advantages over the prior art: As a result of the applying of a reactive polycarboxylic acid derivative and the applying of the cellulose atop the carrier material being carried out in separate steps there is no need to effect modifications at the molecules such that the two reactions are only possible in the same solvent. Applying the cellulose atop the polycarboxylic acid derivative already attached to carrier material facilitates the control of the thickness of the resulting cellulose layer, and layer construction is not affected by a subsequent coupling reaction.

The reactive polycarboxylic acid derivative reacts substantially spontaneously with the reactive groups of the carrier material which are capable of covalent bonding. When the reactive groups of the carrier material are amino groups, as is preferred, amide bonds will be initially formed in this reaction. Amide bonds can be converted into the hydrolytically stable cyclic imide by heating the carrier material treated in step (a). The bonding of the reactive polycarboxylic acid derivative to the carrier material proceeds only by a small fraction of the reactive groups of the polycarboxylic acid, so that the reactive groups which remain are available for a subsequent reaction with the hydroxyl groups of the cellulose.

Preferred reactive polycarboxylic acid derivatives are copolymers, especially alternating copolymers, comprising as monomers a reactive carboxylic acid derivative, for example maleic anhydride, and a compound of the formula CH₂═CH—R where R is H, alkyl having from 1 to 12 carbon atoms, preferably from 1 to 6 carbon atoms and more preferably from 1 to 3 carbon atoms, O-alkyl having from 1 to 12 carbon atoms, preferably from 1 to 6 carbon atoms and more preferably from 1 to 3 carbon atoms, aryl, preferably phenyl, or heteroaryl.

Examples of preferred reactive polycarboxylic acid derivatives are alternating maleic anhydride copolymers, especially poly(propene-alt-maleic anhydride), poly(styrene-alt-maleic anhydride) or poly(ethylene-alt-maleic anhydride).

The use of reactive polycarboxylic acid derivatives in the form of alternating copolymers makes it possible to produce multilayered sheetlike structures, particles or fibers having a multiplicity of physical-chemical properties as a function of the copolymer used.

The applying of the reactive polycarboxylic acid derivative atop the carrier material is generally effected adsorptively from a solution of from 0.05% by weight to 0.2% by weight and preferably from 0.08% by weight to 0.15% by weight of the reactive polycarboxylic acid derivative in an organic solvent, especially tetrahydrofuran, acetone or 2-butanone. The solution of the reactive carboxylic acid derivative can in principle be applied atop the carrier material using any desired method suitable for applying material from any solution. Examples of such methods are dipping, spraying or spincoating; preferably, the reactive polycarboxylic acid derivative is spuncoated as a thin film atop the carrier material. The reactive polycarboxylic acid derivative in the film reacts substantially spontaneously with the carrier material by forming the carboxamide. Residues of noncovalently bound copolymer can be removed by rinsing with the respective solvent.

Useful carrier materials include silicon compounds, metals, plastics and natural fibers in any desired form, in particular in the form of particles, grids, fibers, membranes, self-supporting films, plates or disks. Preferred carrier materials and forms are silicon disks, microscope slides made of glass, glass or silicon dioxide particles, synthetic textile fibers such as polyamide, natural fibers such as wool or cotton or polymeric membranes or self-supporting films.

The reactive groups of the carrier material which are capable of covalent bonding are generally selected from the group consisting of reactive amino, hydroxyl, sulfhydryl and carboxyl groups, in particular reactive amino groups.

Carrier materials such as wool, cotton or polyamides already possess groups reactive toward, capable of covalent bonding with, the polycarboxylic acid or one of its derivatives. Other carrier materials, examples being silicon disks or glasses, first have to be provided with reactive groups capable of covalent bonding before the reactive polycarboxylic acid derivative is applied. In a preferred embodiment of the present invention, carrier materials comprising no groups reactive toward, capable of covalent bonding with, the polycarboxylic acid derivative are provided with reactive amino groups by reacting with amine-terminated alkylsilanes or by low pressure plasma treatment in ammoniacal atmospheres before the polycarboxylic acid derivative is applied.

The reaction with amine-terminated alkylsilanes is effected for example by surfaces of glass being initially oxidized with a mixture of aqueous ammonia solutions and hydrogen peroxide and then surface modified with 3-aminopropyldimethylethoxysilane. The low pressure plasma treatment in ammoniacal atmospheres is preferably utilized to introduce reactive amino groups into polymeric materials, for example into elastomeric poly(dimethylsiloxane).

Before being applied atop the carrier material already modified with a reactive polycarboxylic acid derivative, the cellulose is generally dissolved in N-methyl-morpholine (NMMO) monohydrate at a temperature in the range from 90° C. to 115° C. and preferably at a temperature in the range from 90° C. to 100° C. and applied atop a carrier material from a solution of from 1% by weight to 4% by weight of cellulose at a temperature in the range from 70° C. to 90° C. and preferably at a temperature in the range from 70° C. to 80° C. The carrier material is if appropriate pretempered to a temperature in the range from 40° C. to 120° C. and in particular to a temperature in the range from 40° C. to 80° C. If appropriate, the cellulose solution in NMMO monohydrate may have up to 50% by weight, preferably from 20% to 50% by weight of dimethyl sulfoxide (DMSO) or dimethylformamide (DMF) added to it (based on the resulting mixture of NMMO/DMSO or NMMO/DMF) to adjust the viscosity before application. A lower viscosity facilitates the subsequent application of the cellulose, the viscosity of the solution steeply rising with the concentration and the molecular weight of the cellulose. The cellulose solution can in principle be applied atop the carrier material using any desired method suitable for applying material from a solution. Examples of such methods are dipping, spraying or spincoating: preferably, the cellulose is spuncoated as a thin film atop the carrier material which has been provided with the reactive polycarboxylic acid derivative.

If appropriate, up to 2% by weight of an antioxidant (based on NMMO or NMMO/DMSO mixture), for example propyl gallate, may additionally be added to the cellulose solution.

After the cellulose solution has been applied atop the carrier material, there is generally a further step in which the cellulose is precipitated in deionized water, isopropanol or a mixture thereof on the carrier material. Depending on the precipitation medium, the structure of the precipitated cellulose layers may be influenced in the course of the step. The precipitating is preferably carried out in deionized water. The multilayered sheetlike structures, particles or fibers produced by the process of the present invention are air dried, vacuum treated at a temperature in the range from 30° C. to 100° C. and preferably at a temperature in the range from 70° C. to 90° C., and solvent residues still present are removed by intensive washing with deionized water. The samples are subsequently again vacuum dried at a temperature in the range from 20° C. to 40° C. and preferably at a temperature in the range from 25° C. to 35° C.

The present invention further provides multilayered sheetlike structures, particles or fibers obtainable by the process of the present invention.

The structure of the multilayered sheetlike structures, particles or fibers is influenced via various process parameters. The layer thickness of the reactive polycarboxylic acid derivative atop the carrier material is dependent on the molecular weight of the reactive polycarboxylic acid derivative and also on the layer-forming conditions. Examples thereof are described in Example 2. The concentration of the cellulose solution influences the thickness of the cellulose layer atop the carrier materials in that the layer of cellulose atop the carrier materials is from 10 nm to 30 nm thick when applied from a 1% solution, from 30 nm to 70 nm thick when applied from a 2% solution and from 130 nm to 300 nm thick when applied from a 4% solution. Examples thereof are described in Example 3. The viscosity of the cellulose solution, adjustable with dimethyl sulfoxide (DMSO) or dimethylformamide (DMF) for example, influences the application of the dissolved cellulose atop the carrier material in that a lower viscosity leads to lower thicknesses for the cellulose layer. A longer spin time likewise leads to a lower thickness for the cellulose layer.

The present invention further provides multilayered sheetlike structures, particles or fibers, in particular multilayered sheetlike structures or particles, comprising reactive polycarboxylic acids bound to a sheetlike, particulate or fibrous carrier material by a covalent bond and a cellulose layer, wherein the cellulose layer consists of a first cellulose layer, bound covalently to the reactive polycarboxylic acids, and a second cellulose layer, bound noncovalently to the first cellulose layer. This noncovalently attached second cellulose layer is nonetheless insolubly bound to the first cellulose layer; that is, it is stable to delamination for 12 hours under shearing stress due to flowing aqueous electrolyte solutions at a pH between 2 and 10.

In one particular embodiment of this aspect of the present invention, the layer thickness of the reactive polycarboxylic acid is in the range from 1 nm to 20 nm, preferably in the range from 3 nm to 10 nm and more preferably in the range from 3 nm to 6 nm, the layer thickness of the first cellulose layer is in the range from 2 nm to 20 nm, preferably in the range from 2 nm to 10 nm and more preferably in the range from 2 nm to 5 nm, and the layer thickness of the second cellulose layer is in the range from 15 nm to 200 nm and preferably in the range from 40 nm to 120 nm in the multilayered sheetlike structures or particles. The thickness of the individual layers is influenceable as described above, inter alia through the choice of polycarboxylic acid derivative and through the concentrations of the solution of the polycarboxylic acid derivative and also of the cellulose.

The present invention further provides for the use of the present invention's process for production of multilayered sheetlike structures, particles or fibers for hydrophilicizing surfaces, in particular for adhesion promotion between hydrophobic and hydrophilic materials and for improving the washability of synthetic fibers, the surfaces which are hydrophilicized by the process forming the sheetlike, particulate or fibrous carrier material.

Improved adhesion between self-supporting films is achievable for example through the use of self-supporting films which were modified with a cellulose layer by means of the process according to the present invention. In general, the present invention's multilayered sheetlike structures, particles or fibers are better water-spreadable, i.e., the wettability of the materials with aqueous fluids is increased. This facilitates easier cleaning, for example an improvement to the washability of synthetic fibers.

### EXAMPLES

### Example 1

### Introducing Reactive Amino Groups

Silicon disks or microscope slides made of glass were freshly oxidized with a mixture of aqueous solutions of ammonia and hydrogen peroxide and subsequently surface-modified with 3-aminopropyldimethylethoxysilane.

Elastomeric poly(dimethylsiloxane)s were provided with reactive amino groups by ammonia plasma treatment. The plasma treatment was carried out in a computer-controlled Microsys from Roth & Rau, Germany. The system consisted of three vacuum chambers (i-iii) connected to a central sample-processing unit. Turbo-molecular pumps maintained the base pressure of the entire vacuum system at 10⁻⁷ mbar. (i) A load-lock chamber made it possible to introduce the samples into the system while maintaining the vacuum in the other chambers. (ii) The plasma treatment utilized a cylindrical vacuum chamber of stainless steel 350 mm in diameter and 350 mm high. A Micropole mass spectrometer from Ferran, USA, was used to monitor residual gas. An RR160 2.46 GHz electron cyclotron resonance (ECR) plasma source from Roth & Rau having a diameter of 160 mm and a maximum power of 800 W was mounted on top of the chamber. The plasma source could be operated in a pulsing mode. The process gas was introduced by means of a gas flow control system into the active volume of the plasma source. Once the plasma source had been switched on, the pressure was measured via a capacitative vacuum-measuring instrument. The samples were moved by the operating unit into the center of the chamber. The distance between the sample position and the excitation volume of the plasma source was about 200 mm. The following parameters were utilized: energy 400 W, pulse frequency 1000 Hz. modulation ratio 5%, ammonia gas flow 15 standard cm³/min, pressure 7×10⁻³ mbar.

### Example 2

### Applying an Alternating Maleic Anhydride Copolymer

Poly(styrene-alt-maleic anhydride) (PSMA), Mw 100000, was dissolved in THF in a concentration of 0.12%, poly(propene-alt-maleic anhydride) (PPMA). Mw 39000, was dissolved in 2-butanone in a concentration of 0.1% and poly(ethylene-alt-maleic anhydride) (PEMA), Mw 125000, was dissolved in 1:2 acetone/THF in a concentration of 0.15%. The copolymer solutions were applied atop pretreated silicon disks or glass slides (see Example 1) by spincoating (RC5, Suess Microtec. Garching, Germany, 4000 rpm, 30 s) or by dipping into the solution. The spontaneously formed covalent bonds of the polymeric films with the aminosilane on the SiO₂ carrier material were converted into cyclic, hydrolytically stable imide bonds by heating the carriers to 120° C. Residues of noncovalently bound copolymer were removed by rinsing with the respective solvent. These conditions led to polycarboxylic acid layer thicknesses of 5±0.5 nm for PMSA. 3 nm±0.5 for PPMA and 4.8±0.5 nm for PEMA.

### Example 3

### Applying Cellulose Atop the Carrier Materials Pretreated According to Examples 1 and 2

0.15 g, 0.3 g and 0.6 g respectively of cellulose (microcrystalline cellulose DP 215-250) were introduced into 9 g of NMMO (with or without addition of 1% by weight (0.09 g) of propyl gallate antioxidant) and heated to 100° C. over 30 min with stirring and thereby dissolved (cellulose concentrations of solutions: 1% by weight, 2% by weight and 4% by weight respectively). The solution was admixed with 6 g of DMSO, resulting in a mixture of 60% of NMMO and 40% of DMSO. After addition of DMSO, the solution was cooled down to 70° C. The solutions thus produced were spincoated at from 45° C. to 50° C. for 15 s or 60 s at 3000 rpm to the microscope slides coated with maleic anhydride copolymers and, if appropriate, pretempered. Subsequently, the cellulose layers were precipitated by dipping the microscope slides into deionized water. After the cellulose layers thus prepared had been air dried overnight, they were vacuum dried at 90° C. for 2 h and then intensively washed (3 times 1 h) with deionized water to remove solvent residues still present. All carrier materials thus coated were again vacuum dried at 30° C. The following overall layer thicknesses were obtained with PEMA polycarboxylic acid as a function of cellulose concentration and spin time:

| Cellulose conc. [wt %] | Spin time [s] | Layer thickness [mm] |
|---|---|---|
| 1 | 15 | 22 ± 2 |
| | 60 | 16 ± 2 |
| 2 | 15 | 58 ± 4 |
| | 60 | 39 ± 2 |
| 4 | 15 | 274 ± 8 |
| | 60 | 172 ± 4 |

### Example 4

### Determination of Layer Thickness

The thickness of the air-dried layers was determined by ellipsometry (VASE 44 M, Woollam, Lincoln, Neb.). The refractive index determined for the cellulose films was 1.54±0.01 (at 630.1 nm).

### Example 5

### Stability of Coatings

The coated silicon disks or glass slides produced according to Examples 1, 2 and 3 were exposed to a shearing stress due to flowing aqueous electrolyte solutions at between pH 2 and 10 for 12 hours. The shearing flow was realized in a rectangular duct (W: 10×L: 20×H: 0.05 mm). Maximum wall shear rates amounted to about 2.8×10⁴ s⁻¹ (corresponding to a 200 mbar pressure difference across the duct). The layers proved stable under these conditions. Stability was demonstrated by XPS measurements before and after the shearing stress was applied to the layers.

### Example 6

### Use of Hydrophilicized Particles

Clay minerals from 10 nm to 100 μm and preferably from 20 nm to 5 μm in size which were coated with cellulose by the process of the present invention being applied to particulate carrier material are used as low-flammability cotton.

1-12. (canceled)

13. A process for producing multilayered sheetlike structures, particles or fibers, the process comprising the separate steps of
(a) applying a reactive polycarboxylic acid derivative atop a sheetlike, particulate or fibrous carrier material already comprising, or previously provided with, groups reactive toward, capable of covalent bonding with, the polycarboxylic acid derivative,
(b) if appropriate heating the carrier material treated in step (a) to a temperature in the range from 60° C. to 130° C. to hasten, complete or further optimize the covalent bonds,
(c) applying atop the carrier material a cellulose capable of covalent bonding with the polycarboxylic acid derivative.

14. The process according to claim 13 wherein the reactive polycarboxylic acid derivative is a copolymer comprising as monomers a reactive carboxylic acid derivative and a compound of the formula CH₂═CH R where R is H, alkyl having from 1 to 12 carbon atoms, O alkyl having from 1 to 12 carbon atoms, aryl or heteroaryl.

15. The process according to claim 13, wherein the applying of the reactive polycarboxylic acid derivative in step (a) is effected from a solution of from 0.05% by weight to 0.2% by weight of the reactive polycarboxylic acid derivative in an organic solvent.

16. The process according to claim 13, wherein the carrier material consists of silicon compounds, metals, plastics or natural fibers and is in any desired form.

17. The process according to claim 13, wherein the reactive groups of the carrier material which are capable of covalent bonding are selected from the group consisting of reactive amino, hydroxyl, sulfhydryl and carboxyl groups.

18. The process according to claim 13, wherein carrier material comprising no groups reactive toward, capable of covalent bonding with, the polycarboxylic acid or one of its derivatives is provided with reactive amino groups by reacting with amine-terminated alkylsilanes or by low pressure plasma treatment in ammoniacal atmospheres before step (a) is carried out.

19. The process according to claim 13, wherein the cellulose is dissolved in N-methylmorpholine monohydrate at a temperature in the range from 90° C. to 115° C. from 0% by weight to 50% by weight of DMSO or DMF is added and the cellulose is applied in step (c) at a temperature in the range from 70° C. to 90° C. from a solution of from 1% by weight to 4% by weight of cellulose in N-methylmorpholine monohydrate to a carrier material which has if appropriate been pretempered to a temperature in the range from 40° C. to 120° C. and, in a further step (d), the cellulose is precipitated in deionized H₂O, isopropanol or a mixture thereof on the carrier material.

20. Multilayered sheetlike structures, particles or fibers, comprising reactive polycarboxylic acids bound to a sheetlike, particulate or fibrous carrier material by a covalent bond and a cellulose layer, wherein the cellulose layer consists of a first cellulose layer, bound covalently to the reactive polycarboxylic acids, and a second cellulose layer, bound noncovalently to the first cellulose layer.

21. The multilayered sheetlike structures, particles or fibers according to claim 20, wherein the layer thickness of the reactive polycarboxylic acid is in the range from 1 nm to 20 nm, the layer thickness of the first cellulose layer is in the range from 2 nm to 20 nm, and the layer thickness of the second cellulose layer is in the range from 15 nm to 200 nm.

22. A method for hydrophilicizing surfaces, comprising the step of forming the surface to be hydrophilicized from multilayered sheetlike structures, particles or fibers obtained by the process according to claim 13.

23. A method for hydrophilicizing surfaces, comprising the step of forming the surface to be hydrophilicized from the multilayered sheetlike structures, particles or fibers according to claim 20.
